(19) United States
(12) Patent Application Publication
(10) Pub. No.: US 2014/0262889 A1
(43) Pub. Date: Sep. 18, 2014

(54) BILLBOARD EFFECT STACKING SYSTEM AND METHOD

(71) Applicant: Jiajing USA, Inc., Richmond (CA)

(72) Inventor: Gary M. Wahrmund, Fort Worth, TX (US)

(21) Appl. No.: 14/213,435

(22) Filed: Mar. 14, 2014

Related U.S. Application Data
(60) Provisional application No. 61/791,988, filed on Mar. 15, 2013.

(51) Int. Cl. B65D 5/42; B65D 19/38; B65G 57/22; B65D 21/00

(52) U.S. Cl. CPC B65D 5/425; B65D 21/00; B65D 19/38; B65G 57/22
USPC 206/386; 206/459.5; 414/802

(57) ABSTRACT

Improved system and method embodiments of displaying boxed products, such as compressible bedding products, are disclosed. For example, the orientation of boxes on pallets or other surfaces may provide enhanced display effect for sales, for example a billboard effect in which a single image may span more than one box in a stack. Some systems and methods may also apply to boxed products on shelving.

### CROSS-REFERENCE TO RELATED APPLICATIONS

This application is related as a non-provisional of and claims benefit under 35 U.S.C. §119 to U.S. Provisional Patent Application Ser. No. 61/791,988 entitled “Billboard Effect Stacking System and Method” and filed Mar. 15, 2013, which is assigned to the Assignee of the present application and hereby incorporated by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Typically, much of the transportation of goods within the United States takes place using trucking, with big rig eighteen wheelers moving boxes of goods, for example. Often, the boxed goods are packed on pallets, and then loaded into the truck trailers and/or flatbeds (for example, with fork lifts moving the loaded pallets onto the trucks). Loaded pallets might also be loaded for transport on train rail cars. And while pallets are primarily used to transport packaged goods, in big box warehouse stores such as Costco and Sams Club for example, the loaded pallets may actually be placed on the floor for display and sale of goods (to end user consumers for example). It may also be advantageous in other contexts to effectively stack product (typically in boxes) in a way that may help display the product for sale. Based on this type of consideration, Applicant has developed improved systems and methods for displaying packaged goods (typically in stacks) on a pallet (or elsewhere), which may be useful in increasing the sales to end user customers at big box warehouse stores for example. These and other improvements are discussed below in more detail.

### SUMMARY

Aspects of the disclosure may include embodiments of a box stacking system with billboard effect, comprising: a plurality of rectangular boxes having square end panels and four longitudinal panels; wherein: the boxes all have the same size and shape (dimensions) (and image display); an image spans at least two sequential (adjacent) longitudinal panels of each box; and at least two boxes are stacked to provide a billboard effect.

Additional aspects of the disclosure may include embodiments of a method of stacking boxes for billboard effect comprising: placing a first rectangular box, having square end panels and four longitudinal rectangular panels, onto a surface (with one of the longitudinal panels face down on the surface); stacking a second, vertically adjacent rectangular box on top of the first box (with one of the rectangular longitudinal panels of the second box face down atop one of the longitudinal rectangular panels of the first box); wherein: each box has the same size, shape (dimensions) and image display; a single composite image spans at least two sequential longitudinal side panels of each box; and the second box is rotated (oriented) with respect to the first box so that the vertically adjacent box longitudinal side panels display (at least a portion of) the composite image.

Other aspects of the disclosure may include embodiments of a pallet loading system with a billboard effect, comprising: a pallet; and a plurality of rectangular boxes having square end panels and four longitudinal panels; wherein the boxes all have the same size and shape (dimensions) (and image display); an image spans at least two adjacent longitudinal panels of each box; and at least two boxes are stacked on the pallet to provide a billboard effect.

Yet other aspects of the disclosure may include embodiments of a method of loading a pallet for billboard effect comprising: placing a first rectangular box, having square end panels and four longitudinal rectangular panels, onto a pallet (with one of the longitudinal panels face down on the surface of the pallet); stacking a second, vertically adjacent rectangular box on top of the first box (with one of the rectangular longitudinal panels of the second box face down atop one of the longitudinal rectangular panels of the first box); wherein: each box has the same size, shape (dimensions) and image display; a single composite image spans at least two sequential longitudinal side panels of each box; and the second box is rotated (oriented) with respect to the first box so that the vertically adjacent box longitudinal side panels display (at least a portion of) the composite image.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an exemplary pallet loading system for compressible bedding products using billboard effect;

FIGS. 2A and 2B illustrate the panels of an exemplary rectangular box;

FIGS. 2C and 2D illustrate alternative perspective views of the box of FIG. 2A;

FIGS. 2E and 2F illustrate exemplary panels of a rectangular box with a composite image spanning two sequential longitudinal panels;

FIG. 3 illustrates the panels of an exemplary rectangular box having a composite image spanning all four longitudinal panels;

FIG. 4A illustrates an exemplary pallet system with a composite image spanning four vertically adjacent boxes in a stack to create a billboard effect;

FIGS. 4B and 4C illustrate an exemplary pallet with the same billboard effect for a plurality of parallel stacks of boxes;

FIGS. 5A-5B illustrate a front elevation view of exemplary shelf stacking systems; and

FIG. 5C illustrates a perspective view of an exemplary shelf stacking system having parallel stacks (with one box removed from the front stack).

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “box” means a relatively stiff or rigid (for example, not readily conforming, but maintaining its own shape independent of the product within it) enclosure (e.g. container) capable of being stacked; a box may be formed of any material capable of providing the necessary characteristics, such as cardboard or plastic by way of example;

The term “square” means a specific type of rectangle, in which all sides are approximately the same length (e.g. a quadrilateral with four right angles and four straight sides of approximately equal length);

The term “comprising” means including but not limited to, and should be interpreted in the manner it is typically used in the patent context;

The phrases “one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or approximately” or the like, when used with a number, may mean that specific number, or alternatively, a range in proximity to the specific number, as understood by persons of skill in the art field, for example +/−10%; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

FIG. 1 illustrates an exemplary embodiment of a pallet loading system having a billboard effect. This is merely an exemplary use of such a billboard effect system for a pallet, for example based on boxes of compressible bedding product. While the arrangement of stacks of boxes on the pallet may be helpful in increasing the product density on the pallet, any arrangement of boxes that employs stacks may make use of a billboard effect system of the type shown illustratively in FIG. 1. The system of FIG. 1 comprises a rectangular pallet 20 and a plurality of rectangular boxes 30. The pallet has longitudinal sides 22 and lateral sides 24 (with the longitudinal sides having greater length than the lateral sides). Each of the boxes 30 has the same shape and size (dimensions), with each having two square end panels 32 with equal square sides 33 and four rectangular longitudinal panels 36 with lateral sides 37 equal to the square sides 33 in length and longitudinal sides 38 (with length greater than the square sides). The longitudinal side 38 length of the boxes in FIG. 1 is approximately the same as the lateral side 24 length of the pallet, and the longitudinal side 22 length of the pallet in FIG. 1 is approximately the same as the longitudinal side 38 length of the boxes plus the square side 33 length of the boxes.

A lateral stack 50 of boxes 30 is located with an outer longitudinal panel 36a of each box in the lateral stack approximately flush in line/plane with (e.g. in proximity to) one of the lateral side 24 edges of the pallet 20. Additionally, a plurality of longitudinal stacks 60 of boxes 30 are each located with one of the square end panels 32 of the boxes in each longitudinal stack 60 approximately flush with the interior longitudinal panel 36b of the boxes in the lateral stack 50, and the longitudinal sides 38 of the boxes in the longitudinal stacks 60 extending perpendicular from the lateral stack 50 in (i.e. along and/or parallel to) the longitudinal side 22 length of the pallet 20 (so that the other square end panel 32 of the boxes in each longitudinal stack 60 is located in proximity (typically parallel) to the other lateral side 24 of the pallet 20 (i.e. the lateral pallet side that does not contain the lateral stack of boxes). Also, each of the plurality of longitudinal stacks 60 of boxes 30 in FIG. 1 is approximately flush against at least one adjacent longitudinal stack of boxes (with longitudinal panels approximately flush).

In the system shown in FIG. 1, each stack 50 and 60 comprises the same number of boxes (for example, each stack might typically have 5 boxes). The pallet 20 in FIG. 1 is a standard pallet, having a longitudinal side 22 length of about 48 inches and a lateral side 24 length of about 40 inches. And in FIG. 1, each box 30 comprises an image spanning at least two longitudinal panels 36, so that the orientation of the boxes 30 in the stacks may produce a billboard effect (as described in more detail below).

As shown for example in FIG. 1, the billboard effect, in which a single image spans multiple boxes within a stack (for example, boxes stacked on a pallet), can produce larger images than would be possible based on the size of just a single box for improved display effect. This may allow for larger image display for pallets, which might be particularly effective as a point-of-sale tool when products are sold directly off the pallet (for example, in warehouse stores such as Costco and Sams Club) or other stacking arrangements (for example on shelves in stores without a pallet). Such a billboard effect pallet loading approach may be used independently, or it may be used in conjunction with the efficient pallet loading system and/or method described above, as shown in FIG. 1 for example (and described in more detail in related application Ser. No. 14/213,296, hereby incorporated by reference in all respects except those, if any, in direct conflict with details herein). And the billboard effect may be used independently of pallets as well (for example, in other sales contexts in which boxes of product are stacked for display). An exemplary embodiment of a billboard effect pallet loading system as shown illustratively in FIG. 1 might comprise: a pallet 20; and a plurality of rectangular boxes 30 each having square end panels and four longitudinal panels; wherein the boxes all have the same size and shape (dimensions) (and image display); an image 100 spans at least two sequential longitudinal panels 36c and 36d of each box 30; and at least two boxes 30 are stacked on the pallet 20 to provide a billboard effect. Typically, the at least two boxes 30 in the stack are oriented so that vertically adjacent boxes 30a and 30b have longitudinal panels oriented to jointly display the image 100 (to create the billboard effect). For example, rotation (for example, about the longitudinal axis) of the boxes 30 in a stack might orient longitudinal panels of vertically adjacent boxes 30a and 30b to form a composite image 100 spanning multiple boxes.

Generally, the image on each of the boxes is a composite image 100 formed of at least two subimages 110 and 120, with the at least two subimages located on sequential longitudinal panels 36c and 36d of each of the boxes 30 (as shown in FIGS. 2A-F). Rotation (or orientation) of vertically adjacent boxes 30a and 30b in a stack (for example, on a pallet or shelf) forms the billboard effect by displaying the subimages 110 and 120 on sequential longitudinal panels 36c and 36d (in a plane) to form the composite image 100 spanning the at least two boxes 30 in the stack. It should be understood that up to four subimages might be used for typical rectangular boxes (with up to six subimages perhaps being possible in embodiments using square boxes), with the four longitudinal panels each containing one of the subimages in sequential order. Such an embodiment is shown in FIGS. 3 and 4A, with the composite image spanning all four longitudinal panels of each box. The composite image of FIG. 3 is formed of four subimages, and the four subimages are located on sequential longitudinal panels of each box. This allows the boxes 30 to be oriented on the pallet 20 as shown in FIG. 4A for example, to display a billboard effect in which a large composite image 100 spans four boxes in a stack.

While each stack could employ billboard effect to display one or more composite images on its own, multiple parallel stacks (typically flush against one another) could also be arranged to work together so that, as boxes are removed from the pallet, the composite image may still be displayed by using the combination of the subimages in the outer stack with the subimages on revealed boxes of one or more inner stacks. Typically, the boxes would be stacked in multiple parallel stacks flush against one another, with each stack having boxes oriented in the same way/pattern forming the billboard effect. That way if a box is removed from an outer stack, the composite image still might be displayed (when viewed from a distance for example) based on subimages on a combination of boxes from the outer stack and one or more revealed inner stacks. FIG. 4B illustrates display of the composite image 100 when one box is removed from an outer stack 461 of the parallel stacks, while FIG. 4C illustrates display of a composite image when two boxes are removed from an outer stack 461 and one box is removed from the adjacent inner stack 463. This use of parallel stacks of boxes oriented the same way may provide for a more robust billboard effect, capable of displaying the composite image for a longer period of time even as boxes are removed from the pallet. Specifically, when viewed from a distance, the perspective may allow for the subimage(s) from the revealed (and so now visible) inner stack(s) of boxes to appear in the same visual plane as the subimages from remaining boxes in the outer stack to form a composite image. The image 100 (with multiple subimages on sequential longitudinal panels of the box) could be formed on the boxes 30 in any number of ways. For example, the composite image could be formed on the boxes via litholaminate process (as shown in FIGS. 2E and 2F), or in other embodiments, the image could be formed on the boxes via an enwrapping sleeve about each boxes longitudinal panels.

So in stacking boxes according to an exemplary method embodiment for billboard effect, a first rectangular box, having square end panels and four longitudinal rectangular panels, might be placed onto a pallet or shelf or other surface (with one of the longitudinal panels face down on the surface); and then a second, vertically adjacent rectangular box might be stacked on top of the first box (with one of the rectangular longitudinal panels of the second box face down atop one of the longitudinal rectangular panels of the first box). Typically, each box would have the same size, shape (dimensions) and image display, with a single composite image spanning at least two sequential longitudinal side panels of each box. Then, the second box might be rotated (oriented) with respect to the first box so that the vertically adjacent box longitudinal side panels display (at least a portion of) the composite image. If the composite image spans additional sequential longitudinal panels, then a third (and optionally fourth) vertically adjacent box might be added to the stack and rotated as required to display additional portions of the composite image (with the composite image spanning the at least two boxes). In some embodiments, using square boxes, the composite image may span two or more sequential sides of the box (as the box is rotated about an axis); typically such square boxes would not have the composite image span the end panels. It may be possible, however, that the composite image could span all six square sides, so that rotation of the box along two axes might allow for one or more stacks of six boxes to create the composite image on the pallet. Such a billboard effect stacking method could also be used for areas other than on a pallet (for example, on a shelf) in other embodiments.

More specifically, the composite image may be formed of at least two subimages. One of the at least two subimages is typically located on one of the longitudinal panels of each box, and another of the at least two subimages is typically located on another of the longitudinal panels of each box sequentially oriented with respect to the first subimage longitudinal side panel (as shown in the embodiments of FIGS. 2A-2D for example). The vertically adjacent stacked boxes would then be oriented so that the at least two subimages would be displayed to form the composite image across the at least two boxes in the stack (e.g. so that the composite image is formed spanning the at least two boxes in the stack, as shown in FIG. 1 for example). Loading the pallet might also include continuing to stack and orient boxes in a first stack to provide billboard effect (to form the composite image spanning at least two boxes in the stack).

Additionally, as shown in the embodiments of FIGS. 4A-C, the method of loading the pallet (or other surface) might further comprise forming a second (or more) parallel stack of boxes with boxes oriented identical to the first stack of boxes (i.e. to provide the same billboard effect as the first stack), with the stacks typically having longitudinal panels approximately flush. So, a plurality of such stacks might be formed on the pallet (with boxes oriented for billboard effect, so that removal of a box from the outer stack would reveal a box from the adjacent inner stack(s) to complete the composite image for the billboard effect). In the embodiment of FIGS. 4A-C, the lateral stack may also employ the billboard effect (with the lateral stack having a composite image spanning two or more boxes, and with the plurality of longitudinal stacks also employing the billboard effect by having a composite image span two or more boxes in each longitudinal stack and having the boxes in each longitudinal stack oriented in the same manner). This stacking approach may allow for the lateral stack end of the pallet to be placed for display on an end cap (e.g. the end of a row of pallets). In some embodiments, the composite image may be affixed to the box by litholaminate process, while in other embodiments the composite image may be affixed to the box via a sleeve enwrapping each box. In still other embodiments, the composite image may be printed on the boxes, spanning at least two longitudinal sides of each box. The result of these pallet loading method embodiments typically would be a loaded pallet with billboard effect.

While the bulk of this disclosure has dealt with systems and method for use with pallets (for transportation and display of products), Applicant has also recognized that some of the same principles might be employed for display on shelves (or other surfaces such as floors) in stores. Specifically, using boxes with subimages of a composite image spanning multiple sequential sides of the boxes may allow for product in boxes to be stacked on a surface in a store for more effective display using the billboard effect. FIGS. 5A-5C illustrate an exemplary billboard stacking system and may comprise: stacking two or more boxes on a surface to form a billboard effect, with a composite image spanning the two or more boxes. At least two of the panels (for example two of the longitudinal panels for rectangular boxes) of the boxes in the stack would be oriented (for example, rotated) so that the composite image would be formed spanning the two or more boxes (when viewed from the front plane perspective for example), as shown in FIGS. 5A-5B. As FIG. 5C shows, two or more parallel stacks of boxes may be placed and oriented on the surface to provide a more robust billboard effect (so that removal of one or more boxes from the front (e.g. outer) stack would reveal box(es) in the parallel stack(s) to continue the billboard effect across stacks by having the composite image formed in the front plane). In such an approach, the boxes in each of the parallel stacks typically would be oriented in the same manner (e.g. each stack would be identical in box orientation). Persons of skill will appreciate that the billboard effect discussed above with respect to pallets can also be used for stacks of boxes on other surfaces (such as a shelf or floor for example).

So in some embodiments, the boxes in each stack may have an image and be oriented to form a billboard effect (displaying a composite image across two boxes based on each box having subimages on different longitudinal panels). If billboard effect is used, the boxes of the inner stack typically might have the same orientation as those in the outer stack (so that even when one of the boxes in the outer stack is removed, the composite image might be displayed based on the revealed box of the inner stack in conjunction with the remaining box of the outer stack).

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A pallet loading system with billboard effect, comprising:
a pallet; and
a plurality of rectangular boxes having square end panels and four longitudinal panels;
wherein:
the boxes all have the same size and shape;
an image spans at least two sequential longitudinal panels of each box;
at least two boxes are stacked on the pallet to provide a billboard effect.

2. The system of claim 1 wherein at least two boxes in the stack are oriented so that vertically adjacent boxes have longitudinal panels oriented to jointly display the image to create the billboard effect.

3. The system of claim 1 wherein in a stack, rotation of the boxes orients longitudinal panels of vertically adjacent boxes to form a composite image spanning multiple boxes.

4. The system of claim 1 wherein the image on the boxes is a composite image formed of at least two subimages, with the two subimages located on sequential longitudinal panels of the boxes.

5. The system of claim 4 wherein rotation of vertically adjacent boxes in a stack forms the billboard effect by displaying the subimages on sequential longitudinal panels to form the composite image spanning the at least two boxes in the stack.

6. The system of claim 5 wherein the composite image spans all four longitudinal panels of each box, the composite image is formed of four subimages, and the four subimages are located on sequential longitudinal panels of each box.

7. The system of claim 1 wherein the image is formed on the boxes via litholaminate process.

8. The system of claim 1 wherein the image is formed on the boxes via an enwrapping sleeve about each boxes longitudinal panels.

9. The system of claim 1 wherein the boxes are stacked in multiple parallel stacks flush against one another, with each stack having boxes oriented in the same way forming the billboard effect.

10. A method of loading a pallet for billboard effect comprising:
placing a first rectangular box, having square end panels and four longitudinal rectangular panels, onto a pallet;
stacking a second, vertically adjacent rectangular box on top of the first box;
wherein:
each box has the same size and shape;
a single composite image spans at least two sequential longitudinal side panels of each box; and
the second box is rotated with respect to the first box so that the vertically adjacent box longitudinal side panels display at least a portion of the composite image.

11. The method of claim 10 wherein:
the composite image is formed of at least two subimages;
one of the at least two subimages is located on one of the longitudinal panels of each box;
another of the at least two subimages is located on another of the longitudinal panels of each box sequentially oriented with respect to the first subimage longitudinal side panel; and
the vertically adjacent stacked boxes are oriented so that the at least two subimages are displayed to form the composite image across the at least two boxes in the stack.

12. The method of claim 10 further comprising continuing to stack and orient boxes in a first stack to provide billboard effect.

13. A box stacking system with billboard effect, comprising:
a plurality of rectangular boxes having square end panels and four longitudinal panels;
wherein:
the boxes all have the same size and shape;
an image spans at least two sequential longitudinal panels of each box;
at least two of the plurality of boxes are stacked to provide a billboard effect.

14. The system of claim 13 wherein at least two boxes in the stack are oriented so that vertically adjacent boxes have longitudinal panels oriented to jointly display the image.

15. The system of claim 13 wherein in a stack, rotation of the boxes orients longitudinal panels of vertically adjacent boxes to form a composite image spanning multiple boxes.

16. The system of claim 13 wherein the image on the boxes is a composite image formed of at least two subimages, with the two subimages located on sequential longitudinal panels of the boxes.

17. The system of claim 16 wherein rotation of vertically adjacent boxes in a stack forms the billboard effect by displaying the subimages on sequential longitudinal panels to form the composite image spanning the at least two boxes in the stack.

18. The system of claim 13 wherein the boxes are stacked in multiple parallel stacks flush against one another, with each stack having boxes oriented in the same way forming the billboard effect.

19. A method of stacking boxes for billboard effect comprising:
placing a first rectangular box, having square end panels and four longitudinal rectangular panels, onto a surface;
stacking a second, vertically adjacent rectangular box on top of the first box;
wherein:
each box has the same size and shape;
a single composite image spans at least two sequential longitudinal side panels of each box; and
the second box is rotated with respect to the first box so that the vertically adjacent box longitudinal side panels display at least a portion of the composite image.

20. The method of claim 19 wherein:
the composite image is formed of at least two subimages;
one of the at least two subimages is located on one of the longitudinal panels of each box;
another of the at least two subimages is located on another of the longitudinal panels of each box sequentially oriented with respect to the first subimage longitudinal side panel; and
the vertically adjacent stacked boxes are oriented so that the at least two subimages are displayed to form the composite image across the at least two boxes in the stack.
